(19) United States
(12) Patent Application Publication
(10) Pub. No.: US 2026/0104951 A1
(43) Pub. Date: Apr. 16, 2026

(54) DYNAMIC APPLICATION PROGRAMMING INTERFACES

(71) Applicant: INTERNATIONAL BUSINESS MACHINES CORPORATION, ARMONK, NY (US)

(72) Inventors: LI XUE AN, Beijing (CN); Peng Hui Jiang, Beijing (CN); Mai Zeng, Shi Jing Shan (CN); Xin Xin Dong, Beijing (CN)

(21) Appl. No.: 18/914,416

(22) Filed: Oct. 14, 2024

(51) Int. Cl. G06F 9/54

(52) U.S. Cl. CPC G06F 9/547

(57) ABSTRACT

One or more computer processors intercept an application programming interface (API) request to at least one API server of a plurality of API servers from at least one requesting client in a plurality of requesting clients. The computer-implemented method responsive to intercepting the API request, generate an API response utilizing a predicted filter map. The computer-implemented method send the generated API response to the at least one requesting client in the plurality of requesting clients.

### BACKGROUND

The invention relates generally to the field of application programming interfaces, and more particularly to dynamic application programming interfaces.

An application programming interface (API) is a type of software interface, offering a service to other pieces of software. REST (REpresentational State Transfer) is a software architectural style that was created to guide the design and development of the architecture for the World Wide Web. REST defines a set of constraints for how the architecture of a distributed, Internet-scale hypermedia system, such as the Web, should behave. The REST architectural style emphasizes uniform interfaces, independent deployment of components, the scalability of interactions between them, and creating a layered architecture to promote caching to reduce user-perceived latency, enforce security, and encapsulate legacy systems. REST defines six guiding constraints: clients are separated from servers by a well-defined interface, a specific client does not consume server storage when it is “at rest” (i.e., stateless), responses indicate own cacheability, uniform interface, layered system, and code on demand where servers are able to temporarily extend or customize the functionality of a client by transferring logic to the client that can be executed within a standard virtual machine.

### SUMMARY

Embodiments of the invention disclose a computer-implemented method, a computer program product, and a system. The computer-implemented method includes one or more computer processers intercepting an application programming interface (API) request to at least one API server of a plurality of API servers from at least one requesting client in a plurality of requesting clients. The computer-implemented method responsive to intercepting the API request, generate an API response utilizing a predicted filter map. The computer-implemented method send the generated API response to the at least one requesting client in the plurality of requesting clients.

### BRIEF DESCRIPTION OF THE DRAWINGS

FIG. 1 is a functional block diagram illustrating a computing environment, in accordance with an embodiment of the invention;

FIG. 2 is a flowchart depicting operational steps of a program, on a computer within the computing environment of FIG. 1, for dynamic proxying of application programming interfaces, in accordance with an embodiment of the invention; and

FIG. 3 is an example illustrating client model training steps within the computing environment of FIG. 1, in accordance with an embodiment of the invention.

### DETAILED DESCRIPTION

Representational State Transfer (REST) is a software architecture that imposes conditions on how an application programming interfaces (API) perform. REST is a guideline to manage communication on complex networks like the Internet. API developers design APIs using several different architectures. APIs that follow the REST architectural style are called REST APIs. A RESTful API is an interface that two computer systems use to exchange information securely over the internet.

API programmers integrate multiple parameters into a single interface without considering actual client demands or usage. For example, a client sends an API request and receives a return response with 20 attributes, of which only 10% are used by the client, resulting in redundant information being transmitted and manipulated by both the API server and the requesting client. Redundant or unutilized information results in increased storage utilization and computational requirements while also negatively affecting networking speed and capacity. Traditional APIs do not conform to the demands of every client and provide generic responses to all clients. Traditionally, distinct responses require server side (e.g., API server) code changes that limit system scalability and increase server computational requirements.

Embodiments of the invention dynamically retrieve, modify, and transmit partial API return values. Embodiments of the invention reduce processing and transmission of unutilized or underutilized response attributes from server side systems and networks.

Embodiments of the invention reduce storage constraints and eliminate networking redundancies. Embodiments of the invention collect and scan client code, collect user profile, client information, and server information for model training. Embodiments of the invention train models to analysis returned attributes and generate attribute predictors. Embodiments of the invention dynamically predict the attributes to cache and return based on predicted client need.

According to an aspect of the invention, there is provided a computer-implemented method, computer system, and computer program product to intercept an application programming interface (API) request to at least one API server of a plurality of API servers from at least one requesting client in a plurality of requesting clients; responsive to intercepting the API request, generate an API response utilizing a predicted filter map; and send the generated API response to the at least one requesting client in the plurality of requesting clients. Some aspects of the present invention, detailed above, might reduce the amount of data that needs to be processed and relieve computational resources to perform other processing tasks while increasing network speed and reliability through the network traffic reduction associated with proxied API responses.

In embodiments, there is provided a computer-implemented method, computer system, and computer program product to train a respective client model for each requesting client in a plurality of requesting clients; and train a proxy model from an aggregation of a plurality of trained client models. In embodiments, the specialized training of the models allow for high confidence predictions on both the client level and the API level.

In embodiments, there is provided a computer-implemented method, computer system, and computer program product to responsive to identifying the intercepted API request as new, generate the filter map utilizing the trained proxy model; send the intercepted API request to the at least one API server; intercept an API response; and process the API response according to the filter map. In embodiments, intercepting and processing API responses before data reaches the API server alleviates computational stress on the API server. For example, allowing additional concurrent requesting clients.

In embodiments, there is provided a computer-implemented method, computer system, and computer program product to responsive to identifying the intercepted API request as not new, identify the filter map within the intercepted API request; send the intercepted API request to the at least one API server; intercept an API response; and process the API response according to the filter map. In embodiments, intercepting and processing API responses before data reaches the API server alleviates computational stress (e.g., reduce computational requirements, increases available computational resources) on the API server. For example, allowing additional concurrent requesting clients.

In embodiments, there is provided a computer-implemented method, computer system, and computer program product to validate the generated API response utilizing a monitored error log corresponding to an application associated with the at least one requesting client. In embodiments, validating generated API responses allow for an efficient training loop that advantageously promotes incrementally improved predictive accuracy as more API responses are generated and validated.

In embodiments, there is provided a computer-implemented method, computer system, and computer program product to responsive to the generated API response failing validation, retrain the client model. In embodiments, retraining the client model based on failed responses allows the client model greater flexibility and accuracy responsive to changing client demands.

In embodiments, there is provided a computer-implemented method, computer system, and computer program product to responsive to retraining the client model, retrain the proxy model. In embodiments, retraining the proxy model utilizing retraining client models allows for greater model accuracy while adjusting to aggregated client requirements.

A particular application of an embodiment of the present invention can be using embodiments of the approach described above to dynamically proxy API responses. For example, embodiments of the present method may be implemented on a server or machine that controls the flow of API requests and responses from a client or application to a target API server. The client may transmit an API request to the target API server and the present invention may intercept the API request, preventing the API server from receiving the API request until permitted by the present invention. Embodiments of the present invention may train a client model specific to historical requests and responses with corresponding scanned application information. Embodiments of the present invention may utilize the trained model to generate a filter map that predicts fields and attributes that are utilized by client applications or functions. Embodiments of the present invention may utilize the filter map to generate API responses, from cached responses, based on intercepted API requests. Embodiments of the present invention may return the generated API response to the client, thus freeing computational resources (e.g., network resources) for the API server to direct to other tasks.

Implementation of embodiments of the invention may take a variety of forms, and exemplary implementation details are discussed subsequently with reference to the Figures.

Embodiments of the present invention will now be described in detail with reference to the Figures.

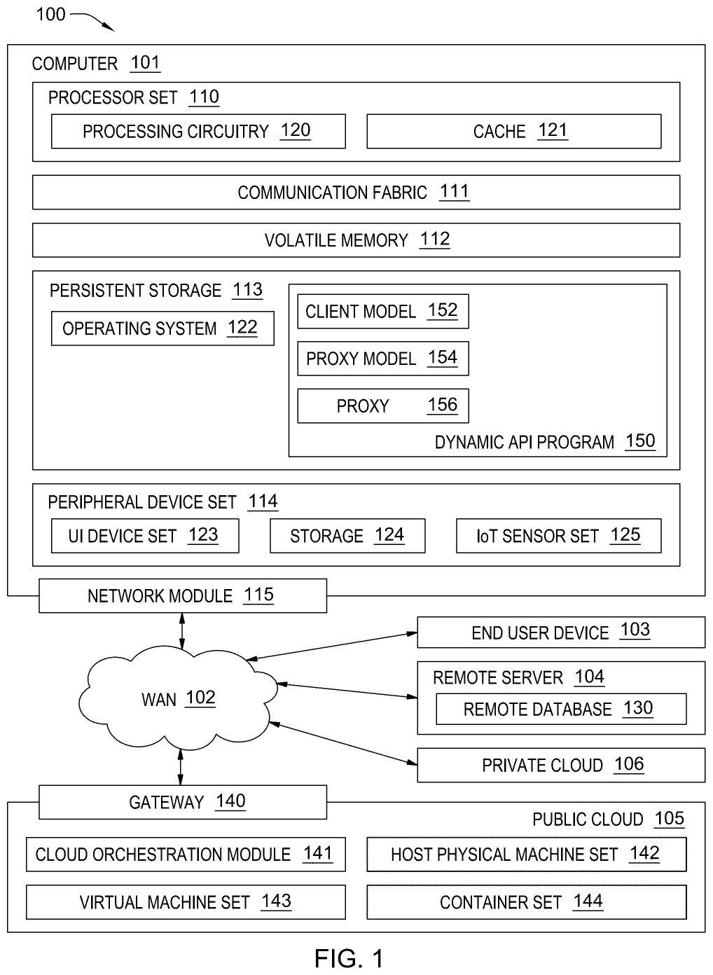

FIG. 1 depicts computing environment 100 illustrating components of computer 101 in accordance with an illustrative embodiment of the invention. It should be appreciated that FIG. 1 provides only an illustration of one implementation and does not imply any limitations with regard to the environments in which different embodiments may be implemented. Many modifications to the depicted environment may be made.

Various aspects of the disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation, or garbage collection, but this does not render the storage device as transitory because the data is not transitory while it is stored.

Computing environment 100 contains an example of an environment for the execution of at least some of the computer code involved in performing the inventive methods, such as API proxy program 150, hereinafter referred to as program 150. In addition to program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip”. In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in program 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

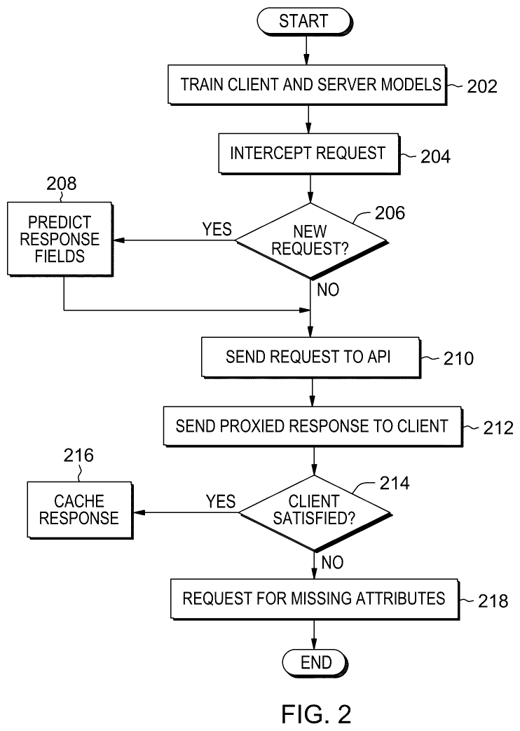

Program 150 is a program, a subprogram of a larger program, an application, a plurality of applications, or mobile application software, which functions dynamically proxy application programming interfaces. In various embodiments, program 150 may implement the following steps: intercepting an application programming interface (API) request to at least one API server of a plurality of API servers from at least one requesting client in a plurality of requesting clients; responsive to intercepting the API request, generating an API response utilizing a predicted filter map; sending the generated API response to the at least one requesting client in the plurality of requesting clients. In the depicted embodiment, program 150 is a standalone software program. In another embodiment, the functionality of program 150, or any combination programs thereof, may be integrated into a single software program. In some embodiments, program 150 may be located on separate computing devices (not depicted) and servers (not depicted) but can still communicate over WAN 102. In various embodiments, client versions of program 150 resides on any other computing device (not depicted) within computing environment 100. In the depicted embodiment, program 150 includes client model 152, proxy model 154, and proxy 156. Program 150 is depicted and described in further detail with respect to FIG. 2.

Client model 152 and proxy model 154 are representative of models utilizing deep learning techniques to train, calculate weights, ingest inputs, and output one or more predictions or solution vectors (e.g., respectively, client attribute predictors and feature maps). In an embodiment, client model 152 and proxy model 154 are comprised of any combination of deep learning model, technique, and algorithm (e.g., decision trees, Naive Bayes classification, support vector machines for classification problems, random forest for classification and regression, linear regression, least squares regression, logistic regression). In an embodiment, client model 152 and proxy model 154 utilize transferrable neural networks algorithms and models (e.g., long short-term memory (LSTM), deep stacking network (DSN), deep belief network (DBN), convolutional neural networks (CNN), compound hierarchical deep models, etc.) that can be trained with supervised or unsupervised methods. The utilization and training of client model 152 and proxy model 154 are depicted and described in further detail with respect to FIG. 2.

Proxy 156 acts as an intermediary between a client requesting an API resource and an API server providing the resource. In an embodiment, proxy 156 receives, requests, or intercepts any API request sent to an exemplary API server from a requesting client. In an embodiment, proxy 156 is attached to an exemplary API server and processes (e.g., receiving, modifying, transmitting) each incoming request and outgoing response. For example, proxy 156 cleans an API response by removing data, information, parameters, or attributes that a requesting client is predicted to not use such as a hidden attribute with ‘_’. In an embodiment, program 150 utilizes proxy 156 to generate a feature map (i.e., heap map) of one or more returned fields, attributes, or values, where for each return value, a corresponding field in the feature map will be one-hot coded. In an embodiment, proxy 156 stores a set of top features based on the generated feature map. For example, proxy 156 stores a top 10 of features (i.e., attributes) based on predicted client request frequency. In another embodiment, proxy 156 receives a Hypertext Transfer Protocol (HTTP) request with RESTful format, and responsively filters (e.g., filter_map) customized attributes while transmitting or returning the filtered response to a requesting client.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

FIG. 2 depicts flowchart 200 illustrating operational steps of program 150 for dynamic proxying of application programming interfaces, in accordance with an embodiment of the invention.

Program 150 trains a client model and a proxy model (step 202). In an embodiment, program 150 initiates responsive to a received or intercepted API request or response. In another embodiment, program 150 initiates responsive to a new client or a new API request from a client. In another embodiment, responsive to a new client, program 150 utilizes a data collection module to collect client information from the new client, where the client information includes user scopes (e.g., service types, user profiles, user preferences, user interfaces) and interface scopes (e.g., API name, API type, function profile, return value, target return value). In another embodiment, program 150 scans code associated with the client and one or more API requests. For example, program 150 scans a function that utilizes one or more returned API values. In this example, program 150 monitors error reporting associated with the scanned function, where an invalid API response will generate errors. In yet another embodiment, program 150 collects and records API server information, where server information includes which clients request one or more attributes at a frequency. In an embodiment, program 150 utilizes the collected client information to create and train client model 152, where client model 152 is utilized to predict one or more attributes based on inputted client information. For example, a client frequently utilizes a subset of attributes contained within an API response in conjunction with a particular application at regular time intervals. In this example, client model 152 is trained to predict attributes utilized by the client for each application, function, or request. In another example, program 150 collects information from a first user that utilizes a post service to request, within a logon interface, a “listProducts”function that returns an API defined set of parameters, attributes, or values.

In an embodiment, program 150 generates a heap map containing returned and verified values for each monitored client and API function, as described in proxy 156. Responsively, program 150 utilizes the generated heap map to train proxy model 154, where proxy model 154 is trained to predict clients that will request particular values at a frequency or temporal range. In another embodiment, program 150 creates a relation map containing functions and expected or predicted return values, pursuant to an API request, for each client monitored by program 150 or intercepted by proxy 156. In an embodiment, responsive to a new API server or a detected change in one or more monitored APIs, program 150 trains or retrains sever model 154. In an embodiment, proxy model 154 is trained with client data collected from each client and each respective trained client model 152.

Program 150 intercepts a request (step 204). In an embodiment, program 150 utilizes proxy 156 to retrieve, receive, or intercept an API request from a client to an API server. In an example, a client transmits an API request for a subset of API parameters, responsively, program 150 utilizes proxy 156 to intercept the API request and hold it for further processing, where the API server does not have an indication of the API request. In an embodiment, the client provides the request with an indication that the client requires a subset of return values usually returned by the API server.

If the request is new, (“yes” branch, decision block 206), then program 150 predicts response fields (e.g., filter map) (step 208). In an embodiment, responsive to the API request from step 204, program 150 verifies if the client is transmitting a new API request. For example, program 150 checks whether a filter map or “filter_map” option is included with the API request, wherein a negative or absent “filter_map” option indicates a new API request. In an embodiment, responsive to a new API request (i.e., an unencountered request or a request with unencountered fields or parameters), program 150 utilizes proxy model 154 to predict which fields or parameters (i.e., “filter_map”) to include in a generated API response. In an embodiment, program 150 utilizes proxy 156 to generate a “filter_map” based on a top N of features (e.g., top 10 features) as determined by proxy model 154. In another embodiment, program 150 utilizes a generated heap map to create the “filter_map”.

If the request is not new, (“no” branch, decision block 206), then program 150 sends a proxied request to an API server (step 210). In an embodiment, responsive to the API request from step 204, program 150 verifies if the client is transmitting a new API request. In an embodiment, program 150 checks whether an “filter_map” option was included with the API request. In another embodiment, the API request includes a format of “/{version}/{resources}/{resource_id}/{filter_map}”, where program 150 utilizes the “filter_map” process a server response. In an embodiment, program 150 utilizes the prediction map to generate or modify an API response utilizing the output of client model 152 associated with the requesting client. In an embodiment, program 150 modifies the API request based on conditions identified within the “filter_map”, such as instructions for combining multiple API responses from distinct API servers. For example, the requesting client transmits an API request to proxy 156 targeting a plurality of API servers, where an associated “filter_map” provides instructions or predictions on which returned values contained in one or more responses from the plurality of API servers will be returned to the requesting client.

Program 150 sends a proxied request to the API server (step 210). In an embodiment, program 150 modifies the client request to conform with one or more specifications associated with a target API server. In an embodiment, program 150 transmits a cached response from a plurality of requesting clients, wherein the plurality of requesting clients have a similar filter_map (e.g., responsive responses contain one or more parameters required for an associated requesting application). In another embodiment, program 150 forwards the client request to the target API server and responsively intercepts any response from the API server.

Program 150 sends proxied response to client (step 212). In an embodiment, program 150 processes or modifies an intercepted API response from step 210. For example, program 150 performs data cleaning on the returned RESTful API response to remove the information that the client will not use, such as hidden attribute with ‘_’. In another embodiment, program 150 processes one or more intercepted API responses based on a provided or predicted “filter_map”. In this embodiment, the processed response is a subset of the one or more intercepted responses. In another embodiment, program 150 adds the values contained in the processed response to the generated heap map within proxy 156.

In an embodiment, program 150 provides the requesting client with the processed response, requesting a callback for verification of the provided response. In another embodiment, program 150 monitors one or more error logs associated with client code that utilizes at least a portion of the values contained in the returned response from proxy 156. For example, an application associated with the requesting client notifies program 150 that the response was insufficient due to one or more missing fields and values.

If client is satisfied (“yes” branch, decision block 214), then program 150 caches the response (step 216). In an embodiment, responsive to an indication of a satisfied client, program 150 caches the returned response and values within proxy 156. In another embodiment, program 150 utilizes cached responses to transmit responses to clients with similar “filter_maps”, where similar “filter_maps” utilize the functions and API servers. In an embodiment, responsive to an accuracy of proxy model 154 reaching a threshold, retraining proxy model 154 with cached responses and corresponding “filter_maps”.

If client is not satisfied (“no” branch, decision block 214), then program 150 requests missing attributes (step 218). In an embodiment, responsive to the client specifying that the proxied response does not contain sufficient values or parameters, program 150 transmits the original request to the API server. In another embodiment, responsively, the API server provides a response to proxy 156 or directly to the requesting client. In an embodiment, program 150 retrains respective client model 152 and proxy model 154 with new or modified training data associated with the missing attributes. In another embodiment, program 150, responsively, regenerates any “filter_map” associated with the requesting client or the target API server.

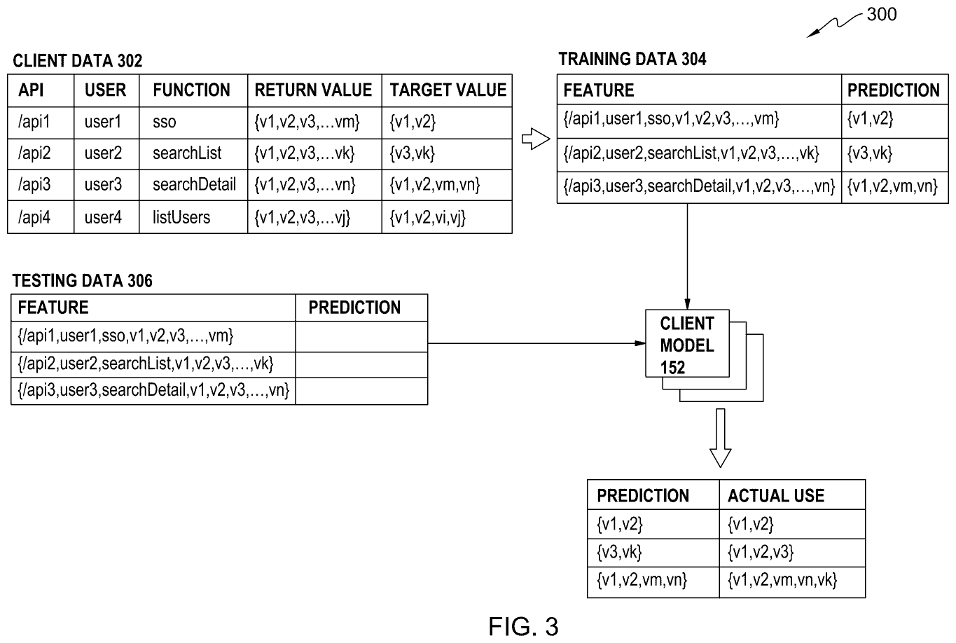

FIG. 3 depicts example 300 illustrating client model training steps, in accordance with an embodiment of the invention. Example 300 includes client data 302 depicting a set of client data collected from client applications, users, and requests; training data 304 depicting a set of training created from client data 302 and utilized to train client model 152; testing data 306 depicting a set of testing data utilized to test client model 152 for predictive accuracy; and client model 152.

What is claimed is:

1. A computer-implemented method comprising:
intercepting an application programming interface (API) request to at least one API server of a plurality of API servers from at least one requesting client in a plurality of requesting clients;
responsive to intercepting the API request, generating an API response utilizing a predicted filter map; and
sending the generated API response to the at least one requesting client in the plurality of requesting clients.

2. The computer-implemented method of claim 1, further comprising:
training a respective client model for each requesting client in the plurality of requesting clients; and
training a proxy model from an aggregation of a plurality of trained client models.

3. The computer-implemented method of claim 2, wherein, responsive to intercepting the API request, generating the API response utilizing the predicted filter map comprises:
responsive to identifying the intercepted API request as new, generating the filter map utilizing the trained proxy model;
sending the intercepted API request to the at least one API server;
intercepting an API server response; and
processing the API server response according to the filter map.

4. The computer-implemented method of claim 2, wherein, responsive to the intercepting API the request, generating the API response utilizing the predicted filter map comprises:
responsive to identifying the intercepted API request as not new, identifying the filter map within the intercepted API request;
sending the intercepted API request to the at least one API server;
intercepting an API server response; and
processing the API server response according to the filter map.

5. The computer-implemented method of claim 2, further comprising:
validating the generated API response utilizing a monitored error log corresponding to an application associated with the at least one requesting client.

6. The computer-implemented method of claim 5, further comprising:
responsive to the generated API response failing validation, retraining the client model.

7. The computer-implemented method of claim 6, further comprising:
responsive to retraining the client model, retraining the proxy model.

8. A computer program product comprising:
one or more computer readable storage media having computer-readable program instructions stored on the one or more computer readable storage media, said program instructions executes a computer-implemented method comprising steps of:
intercepting an application programming interface (API) request to at least one API server of a plurality of API servers from at least one requesting client in a plurality of requesting clients;
responsive to intercepting the API request, generating an API response utilizing a predicted filter map; and
sending the generated API response to the at least one requesting client in the plurality of requesting clients.

9. The computer program product of claim 8, wherein the program instructions, stored on the one or more computer readable storage media, further comprise the steps of:
training a respective client model for each requesting client in the plurality of requesting clients; and
training a proxy model from an aggregation of a plurality of trained client models.

10. The computer program product of claim 9, wherein the program instructions to responsive to intercepting the API request, generate the API response utilizing the predicted filter map, stored on the one or more computer readable storage media, comprise the steps of:
responsive to identifying the intercepted API request as new, generating the filter map utilizing the trained proxy model;
sending the intercepted API request to the at least one API server;
intercepting an API server response; and
processing the API server response according to the filter map.

11. The computer program product of claim 9, wherein the program instructions to responsive to intercepting the API request, generate the API response utilizing the predicted filter map, stored on the one or more computer readable storage media, comprise the steps of:
responsive to identifying the intercepted API request as not new, identifying the filter map within the intercepted API request;
sending the intercepted API request to the at least one API server;
intercepting an API server response; and
processing the API server response according to the filter map.

12. The computer program product of claim 9, wherein the program instructions, stored on the one or more computer readable storage media, further comprise the steps of:
validating the generated API response utilizing a monitored error log corresponding to an application associated with the at least one requesting client.

13. The computer program product of claim 12, wherein the program instructions, stored on the one or more computer readable storage media, further comprise the steps of:
responsive to the generated API response failing validation, retraining the client model.

14. The computer program product of claim 8, wherein the program instructions, stored on the one or more computer readable storage media, further comprise the steps of:
responsive to retraining the client model, retraining the proxy model.

15. A computer system comprising:
one or more computer processors;
one or more computer readable storage media having computer readable program instructions stored on the one or more computer readable storage media for execution by at least one of the one or more processors, the stored program instructions execute a computer-implemented method comprising steps of:
intercepting an application programming interface (API) request to at least one API server of a plurality of API servers from at least one requesting client in a plurality of requesting clients;
responsive to intercepting the API request, generating an API response utilizing a predicted filter map; and
sending the generated API response to the at least one client in the plurality of requesting clients.

16. The computer system of claim 15, wherein the program instructions stored on the one or more computer readable storage media, further comprise the steps of:
training a respective client model for each requesting client in the plurality of requesting clients; and
training a proxy model from an aggregation of a plurality of trained client models.

17. The computer system of claim 16, wherein the program instructions to responsive to intercepting the API request, generate the API response utilizing the predicted filter map, stored on the one or more computer readable storage media, comprise the steps of:
responsive to identifying the intercepted API request as new, generating the filter map utilizing the trained proxy model;
sending the intercepted API request to the at least one API server;
intercepting an API server response; and
processing the API server response according to the filter map.

18. The computer system of claim 16, wherein the program instructions to responsive to intercepting the API request, generate the API response utilizing the predicted filter map, stored on the one or more computer readable storage media, comprise the steps of:
responsive to identifying the intercepted API request as not new, identifying the filter map within the intercepted API request;
sending the intercepted API request to the at least one API server;
intercepting an API server response; and
processing the API server response according to the filter map.

19. The computer system of claim 16, wherein the program instructions, stored on the one or more computer readable storage media, further comprise the steps of:
validating the generated API response utilizing a monitored error log corresponding to an application associated with the at least one requesting client.

20. The computer system of claim 19, wherein the program instructions, stored on the one or more computer readable storage media, further comprise the steps of:
responsive to the generated API response failing validation, retraining the client model.
